(19) United States
(12) Patent Application Publication
(10) Pub. No.: US 2025/0000299 A1
(43) Pub. Date: Jan. 2, 2025

(54) BOTTLE WARMER

(71) Applicant: Shenzhen TPHTechnology Co.,Ltd., Shenzhen (CN)

(72) Inventor: Xianzi CHEN, Shenzhen (CN)

(21) Appl. No.: 18/885,129

(22) Filed: Sep. 13, 2024

(30) Foreign Application Priority Data
Aug. 5, 2024 (CN) 202411065899.5

(51) Int. Cl. A47J 36/24

(52) U.S. Cl. CPC A47J 36/2433

(57) ABSTRACT

A bottle warmer includes a cover having a cavity, a control mechanism including a button and a control panel, a power supply device, a first telescopic part and a second telescopic part. The control panel is provided in the cavity, and the button is provided on a first side of the cover, and is electrically connected to the control panel. The power supply device is provided in the cavity, and the control panel is electrically connected to the power supply device. An end of the first telescopic part is fixedly connected to a second side of the cover. An end of the second telescopic part is telescopically sleeved in the first telescopic part. A side wall of the second telescopic part is provided with multiple heating parts electrically connected to the control panel.

### CROSS-REFERENCE TO RELATED APPLICATIONS

This application claims the benefit of priority from Chinese Patent Application No. 202411065899.5, filed on Aug. 5, 2024. The content of the aforementioned application, including any intervening amendments made thereto, is incorporated herein by reference in its entirety.

### TECHNICAL FIELD

This application relates to baby products, and more particularly to a bottle warmer.

### BACKGROUND

Bottle warmer is mainly used for heating milk or water to a temperature suitable for babies.

The commercially-available portable bottle warmers have a large size, and fail to be simultaneously compatible with different sizes of baby bottles. Moreover, they cannot offer uniform heating, that is, a noticeable temperature difference is raised between the area near the heating point and the area away from the heating point. In this regard, a bottle warmer is developed to solve such problems.

### SUMMARY

In view of this, an object of the present disclosure is to provide a bottle warmer, comprising:
a cover;
a control mechanism;
a power supply device;
a first telescopic part; and
a second telescopic part;
wherein the cover is provided with a cavity;
the control mechanism comprises a button and a control panel, the control panel is provided in the cavity, the button is provided on a first side of the cover, and the button is electrically connected to the control panel;
the power supply device is provided in the cavity, and the control panel is electrically connected to the power supply device;
a first end of the first telescopic part is fixedly connected to a second side of the cover; and
a first end of the second telescopic part is telescopically sleeved in the first telescopic part, a plurality of heating parts are provided on a side wall of the second telescopic part, and the plurality of heating parts are electrically connected to the control panel.

In some embodiments, the first telescopic part comprises a plurality of cylinders which are moveably and sleevedly connected with each other, and the second telescopic part is telescopically provided within an innermost one of the plurality of cylinders.

In some embodiments, a limit part is provided between the first telescopic part and the second telescopic part, and the limit part is provided on the side wall of the second telescopic part, and abuts against an inner wall of the first telescopic part.

In some embodiments, a second end of the first telescopic part is provided with a baffle, the baffle is slidably connected to the side wall of the second telescopic part, and the baffle is configured to prevent the limit part from detaching from the inner wall of the first telescopic part.

In some embodiments, a second end of the second telescopic part is provided with a temperature detection device, and the temperature detection device is electrically connected to the control panel.

In some embodiments, the second side of the cover is provided with a sterilizing device, and the sterilizing device is electrically connected to the control panel.

In some embodiments, the second side of the cover is provided with a circular protrusion, a connection of the first telescopic part with the cover is provided within the circular protrusion.

In some embodiments, the circular protrusion is provided in plurality, and a plurality of the circular protrusions are provided concentrically around a center point of the second side of the cover; and for any adjacent two circular protrusions among a plurality of circular protrusions, one of the adjacent two circular protrusions close to a center point of the second side of the cover is smaller than the other of the adjacent two circular protrusions away from the center point in diameter.

In some embodiments, the cover is provided with a display device, and the display device is electrically connected to the control panel.

In some embodiments, the bottle warmer also comprises an accommodating box detachably connected to the cover, and the first telescopic part and the second telescopic part are configured to extend into the accommodating box.

Compared to the prior art, the present disclosure has the following beneficial effects.

By means of the first telescopic part and the second telescopic part, the bottle warmer of the present disclosure has small size and excellent portability, and can be compatible with baby bottles varying in length. At the same time, the control panel can control the heating part to perform uniform heating through pulse width modulation (PWM).

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated in these drawings without making creative effort.

FIG. 1 schematically shows an assembly structure of a bottle warmer in accordance with an embodiment of the present disclosure;

FIG. 2 schematically shows an assembly between the bottle warmer in accordance with an embodiment of the present disclosure and a baby bottle;

FIG. 3 is a sectional view of the bottle warmer in accordance with an embodiment of the present disclosure;

FIG. 4 is an enlarged view of portion “A” shown in FIG. 3;

FIG. 5 schematically shows an overall structure of the bottle warmer in accordance with an embodiment of the present disclosure;

FIG. 6 is a bottom view of the bottle warmer in accordance with an embodiment of the present disclosure;

FIG. 7 schematically shows a temperature variation of the heating part under control of pulse width modulation (PWM) in accordance with an embodiment of the present disclosure; and

FIG. 8 schematically shows a voltage variation of the heating part under control of PWM in accordance with an embodiment of the present disclosure.

In the figures: 1—cover; 11—cavity; 12—button; 13—display device; 2—control panel; 3—power supply device; 4—first telescopic part; 41—baffle; 5—second telescopic part; 51—heating part; 52—limit part; 53—groove; 6—temperature detection device; 7—sterilizing device; 8—circular protrusion; 9—accommodating box; and 91—anti-slip part.

The realization of the objects, functional features and advantages of the present disclosure will be further described in conjunction with the embodiments and accompanying drawings.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It should be noted that all directional indications (such as up, down, left, right, front, and back) in the embodiments of the present disclosure are used only for explaining the relative positional relationship or movement between the components in a particular attitude (as shown in the accompanying drawings), and the directional indications are correspondingly changed if the particular attitude is changed.

Furthermore, terms such as “first” and “second” are only descriptive, and should not be construed as indicating or implying their relative importance or implicitly specifying the plurality of technical features indicated. As a result, a feature defined as “first” or “second” may include at least one of such feature, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unachievable, it should be understood that such a combination does not exist and is not within the scope of the present disclosure.

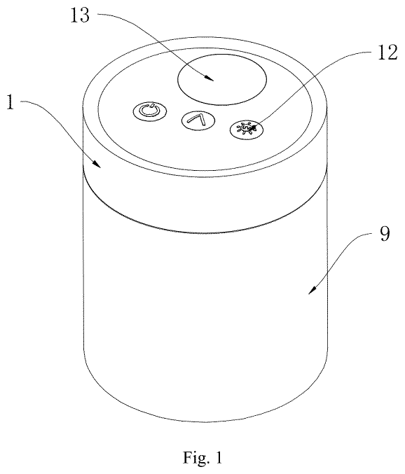

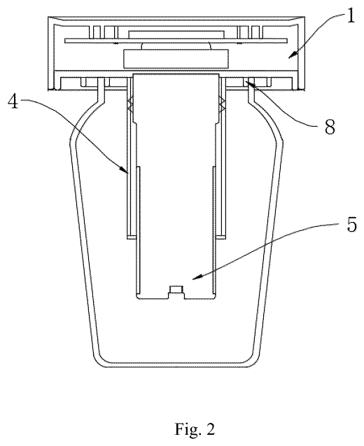

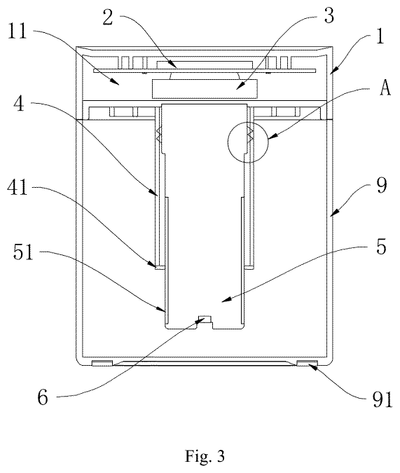

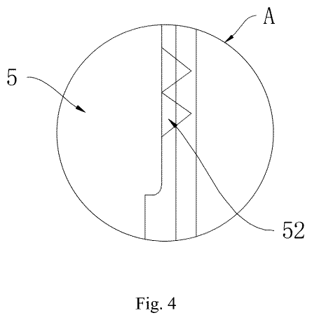

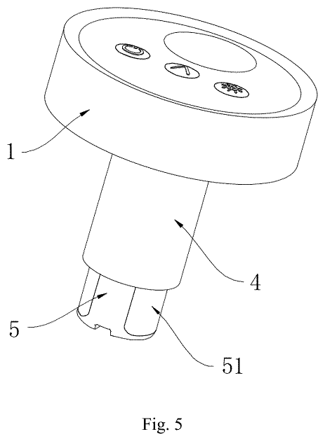

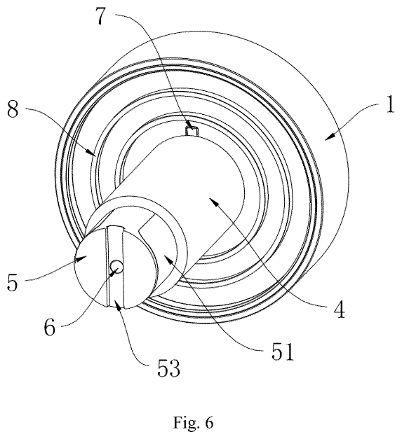

As shown in FIGS. 1-6, an embodiment of the present application provides a bottle warmer, including a cover 1, a control mechanism, a power supply device 3, a first telescopic part 4 and a second telescopic part 5. The cover 1 is provided with a cavity 11. The control mechanism includes a button 12 and a control panel 2. The control panel 2 is provided in the cavity 11, and the button 12 is provided on a first side of the cover 1, and is electrically connected to the control panel 2. The power supply device 3 is provided in the cavity 11, and the control panel 2 is electrically connected to the power supply device 3. A first end of the first telescopic part 4 is fixedly connected to a second side of the cover 1. A first end of the second telescopic part 5 is telescopically sleeved in the first telescopic part 4. A plurality of heating parts 51 are provided on a side wall of the second telescopic part 5, and are electrically connected to the control panel 2.

In this embodiment, the power supply device 3 is a rechargeable battery that is configured to provide power to the control mechanism. The button 12 is provided in plurality, optionally, three buttons 12 are provided, respectively a switch button, a time adjustment button, and a temperature adjustment button. The time adjustment button is configured to set the heating time, and the temperature adjustment button is configured to set the temperature. The buttons 12 are centrally provided at the center of the cover 1 to facilitate the press operation and prevent the occurrence of imbalanced force, so as to prevent the baby bottle from being tipped. Moreover, the button 12 is configured to be waterproof. The control panel 2 is configured to control the heating part 51 by pulse width modulation (PWM) to enable the uniform heating. In some embodiments, the heating part 51 is a heating plate.

The bottle warmer is provided with a first telescopic part 4 and a second telescopic part 5. One end of the second telescopic part 5 is telescopically sleeved in the first telescopic part 4, so that the second telescopic part 5 is configured to be adjusted to be compatible with baby bottles varying in length. The second telescopic part 5 is configured to retract into the first telescopic part 4 when the heating is not required or is completed, allowing for reduced size and improved portability. The cross-sectional shape of the first telescopic part 4 and the second telescopic part 5 are a regular polygon or a circle. Optionally, the first telescopic part 4 and the second telescopic part 5 have a circular cross-sectional shape, at which time the heating part 51 is provided on the side wall of the second telescopic part 5 to increase the heating area of the heating part 51, as well as the contact area of the heating part 51 and a to-be-heated solution. This can accelerate the heating speed, and improve the uniformity of the heating temperature.

Specifically, when heating is required, the second telescopic part 5 is pulled out of the first telescopic part 4 to match the length of the baby bottle, and then the first telescopic part 4 and the second telescopic part 5 are inserted into the baby bottle. The cover 1 is placed over the mouth of the baby bottle, and then the switch button is pressed to start the bottle warmer. Then the heating time is set through the time adjustment button or the temperature is set through the temperature adjustment button. After the time or temperature has been set, the control panel 2 will send a control command to control the heating part 51 for heating, and during the heating process, the control panel 2 can control the heating part 51 to perform uniform heating through PWM. After the heating operation is completed, the second telescopic part 5 is retracted into the first telescopic part 4.

By means of the first telescopic part 4 and the second telescopic part 5, the bottle warmer of the present disclosure has small size and excellent portability, and can be compatible with baby bottles varying in length. At the same time, the control panel 2 can control the heating part 51 to perform uniform heating through pulse width modulation (PWM).

In an embodiment, the first telescopic part 4 includes a plurality of cylinders which are movably and sleevedly connected with each other, and the second telescopic part 5 is telescopically provided within an innermost one of the plurality of cylinders.

In this embodiment, the first telescopic part 4 is provided with a plurality of cylinders to be movably and sleevedly connected with each other is to enable the heating part 51 to be multi-stage telescopic, which can greatly reduce the overall size, improve the portability and simplify the operation.

In an embodiment, a limit part 52 is provided between the first telescopic part 4 and the second telescopic part 5, and the limit part 52 is provided on the side wall of the second telescopic part 5.

In this embodiment, the limit part 52 is a flexible and deformable part, the limit part 52 is in a shape of a bump or an annular strip, and the cross-sectional shape of the limit part 52 is triangular, semi-circular, square, and irregular shapes. Optionally, the limit part 52 is made of rubber, and is provided in plurality.

On the one hand, the limit part 52 abuts against an inner wall of the first telescopic part 4, which forms a seal between the first telescopic part 4 and the second telescopic part 5, preventing the solution from seeping into the interior of the first telescopic part 4 through the gap between the first telescopic part 4 and the second telescopic part 5. On the other hand, the limit part 52 is configured to increase the friction between the first telescopic part 4 and the second telescopic part 5, so that the amount of retraction of the second telescopic part 5 can be controlled.

In an embodiment, a baffle 41 is provided at a second end of the first telescopic part 4, and the baffle 41 is slidably connected to the side wall of the second telescopic part 5.

In this embodiment, the baffle 41 is provided at the second end of the first telescopic part 4 to block the limit part 52, which can prevent the second telescopic part 5 from slipping out of the first telescopic part 4. In addition, it is also possible to scrape and clean the residual solution from the side wall of the second telescopic part 5 when the second telescopic part 5 retracts back to the first telescopic part 4 after the heating is completed.

In an embodiment, a temperature detection device 6 is provided at a second end of the second telescopic part 5, and the temperature detection device 6 is electrically connected to the control panel 2.

In this embodiment, the temperature detection device 6 is provided at the second end of the second telescopic part 5. Specifically, the second telescopic part 5 is provided with a groove 53, and the temperature detection device 6 is provided in the bottom of the groove 53, so that the detected temperature of the solution can be fed back to the control panel 2 during heating. In particular, the purpose of providing the groove 53 is that even if the second telescopic part 5 abuts pressed against the bottom of the baby bottle, the solution can flow into the groove 53 and the temperature detection device 6 can still be able to accurately detect the temperature of the solution.

In an embodiment, the second side of the cover 1 is provided with a plurality of sterilizing devices 7, and the plurality of sterilizing devices 7 are electrically connected to the control panel 2.

In this embodiment, the sterilizing device 7 is provided with a function of ultraviolet (UV) sterilization. Optionally, the sterilizing device 7 is a UV lamp.

Specifically, the corresponding sterilizing button 12 is pressed to send a command to the control panel 2, and then the control panel 2 is configured to control the sterilizing device 7 to sterilize the cover 1, the first telescopic part 4, the second telescopic part 5, and the heating part 51.

In an embodiment, the second side of the cover 1 is further provided with a circular protrusion 8, and a connection between the first telescopic part 4 and the cover 1 is located at a center point of the circular protrusion 8.

In this embodiment, the circular protrusion 8 is a flexible and deformable material, and the cross-sectional shape of the circular protrusion 8 is semi-circular, square or U-shaped. And optionally, the material of the circular protrusion 8 is soft silicone or plastic or silicone-covered rubber. When placing the cover 1 on the baby bottle, align the mouth of the baby bottle with the position of the circular protrusion 8, and gently press down to connect the cover 1 with the mouth of the baby bottle. By means of the circular protrusion 8 can briefly seal the mouth of the baby bottle, so that even if the baby bottle accidentally touches down, there will not be any leakage of milk, at the same time, it can also improve the efficiency of heating.

After the heating is completed, the cover 1 is gently lifted, and the circular protrusion 8 is detached from the mouth of the baby bottle under the gravity of the baby bottle and the liquid therein, so the bottle warmer can be removed by a single hand. Optionally, the user can put the whole palm on the cover 1 and then gently lift one side of the cover 1, so that the side with the circular protrusion 8 is separated from the mouth of the baby bottle to break the seal, and the cover 1 can be removed with one hand. By means of this design, there is no need for extra operation, and it can be used by placing it directly on the baby bottle, allowing for simple operation.

In an embodiment, the circular protrusion 8 is provided in plurality, and a plurality of circular protrusions 8 are provided concentrically around a center point of the second side of the cover; and for any adjacent two circular protrusions among a plurality of circular protrusions, one of the adjacent two circular protrusions close to a center point of the second side of the cover is smaller than the other of the adjacent two circular protrusions away from the center point in diameter.

In this embodiment, the purpose of providing multiple circular protrusions 8 varying in diameter is to fit baby bottles varying in specification (length and mouth diameter) without the need to change the connector.

In an embodiment, the cover 1 is provided with a display device 13, the display device 13 is electrically connected to the control panel 2.

In this embodiment, the display device 13 is provided on the cover 1. And the display device 13 is a display screen. And the display screen can be a touch display screen, which can display a temperature, a heating status indication, a sterilization status indication, a power status indication, and so on.

Optionally, the physical buttons 12 can be eliminated by integrating the buttons 12 with the display device 13, that is, touching the display device 13 to achieve the control.

In an embodiment, the bottle warmer further includes an accommodating box 9 detachably connected to the cover 1, and the first telescopic part 4 and the second telescopic part 5 are configured to extend into the accommodating box 9.

In this embodiment, the cover 1 and the first telescopic part 4 and the second telescopic part 5 can be placed and stored by means of the accommodating box 9. The cover 1 is configured to fit the accommodating box 9 to form an enclosed space, which can prevent the first telescopic part 4 and the second telescopic part 5 from contaminating by an external environment, so that the first telescopic part 4 and the second telescopic part 5 are always in a clean and hygienic state.

The accommodating box 9 is connected to the cover 1 by means of seizing, without the need to set up a threaded connection, so that it can be easily to heat by removing and placing on the baby bottle, and after the heating is completed, the bottle warmer can also be easily to remove with one hand.

In addition, by means of the accommodating box 9 can increase a sterilizing effect of the sterilizing device 7.

In an embodiment, the bottom of the accommodating box 9 is provided with an anti-slip part 91.

In this embodiment, the anti-slip part 91 is an annular rubber ring and is provided at the bottom of the accommodating box 9 by means of inlaying, which can increase the friction at the bottom of the accommodating box 9 and prevent the accommodating box 9 from sliding.

In an embodiment, the control panel 2 can be remotely controlled by an APP on a mobile phone through Bluetooth connection.

In this embodiment, the heating of the bottle warmer can be controlled by using an APP on the mobile phone, so that there is no need to press the button 12 on the bottle warmer. The control commands can be directly sent to the control panel 2 via the APP to control the bottle warmer, which further improves the convenience of use.

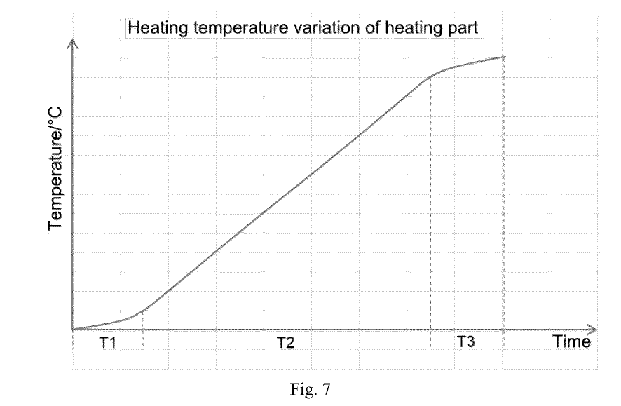

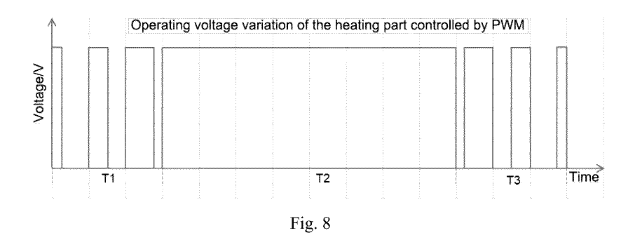

As shown in FIGS. 7-8, in an embodiment, the control panel 2 is configured to control the voltage of the heating part 51 by PWM.

In this embodiment, the voltage variation of the heating part 51 during the heating process is controlled by varying PWM to improve a temperature uniformity of the heating solution and an accuracy of temperature detection.

Specifically, during the T1 period, the duty cycle of the voltage of the PWM-controlled heating part 51 is slowly increasing, during which the heating rate of the heating piece is slower, and the temperature rises slower. This facilitates the temperature to conduct and improve the initial temperature uniformity, which allows the temperature detected by the temperature detection device 6 to be close to the temperature of the overall solution in the baby bottle.

Excessive heating rate at the beginning will make the temperature difference between different positions of the solution too large. Considering that the heat conduction needs a certain period of time, if the heating rate is greater than the rate of the heat conduction, a large temperature difference will occur between the part away from the heating point and the part near the heating point, thereby failing to achieve the uniform heating.

At the T2 period, at this time, after heating at a low power in T1 stage, the overall temperature of the solution is increased and the temperature is uniform, and the temperature detected by the temperature detection device 6 is accurate. At this point, full-power heating (PWM duty cycle of 100%) is started at the T2 stage, which increases the heating rate and does not have to worry about excessive temperature differences within the heated solution. At this time, through the overall temperature of the solution has been increased, and the heating power is constant, so that the heated solution will not produce too large a temperature difference which is constant within the solution.

At the T3 period, when the solution in the baby bottle is close to the set heating temperature, it is heated again at a low-power to reduce the rate of temperature rise, so that the temperature in the solution is uniformly conducted to further improve the consistency of the overall temperature. And at the same time, it can also improve the detecting accuracy of the temperature detection device 6, and further improve the taste of the baby.

Described above are only preferred embodiments of the present disclosure, which are not intended to limit the scope of the present disclosure. It should be understood that various changes, modifications and replacements made by those skilled in the art without departing from the spirit of the disclosure shall fall within the scope of the disclosure defined by the appended claims.

What is claimed is:

1. A bottle warmer, comprising:
a cover;
a control mechanism;
a power supply device;
a first telescopic part; and
a second telescopic part;
wherein the cover is provided with a cavity;
the control mechanism comprises a button and a control panel, the control panel is provided in the cavity, the button is provided on a first side of the cover, and the button is electrically connected to the control panel;
the power supply device is provided in the cavity, and the control panel is electrically connected to the power supply device;
a first end of the first telescopic part is fixedly connected to a second side of the cover; and
a first end of the second telescopic part is telescopically sleeved in the first telescopic part, a plurality of heating parts are provided on a side wall of the second telescopic part, and the plurality of heating parts are electrically connected to the control panel.

2. The bottle warmer of claim 1, wherein the first telescopic part comprises a plurality of cylinders which are movably and sleevedly connected with each other, and the second telescopic part is telescopically provided within an innermost one of the plurality of cylinders.

3. The bottle warmer of claim 1, wherein a limit part is provided between the first telescopic part and the second telescopic part, and the limit part is provided on the side wall of the second telescopic part, and abuts against an inner wall of the first telescopic part.

4. The bottle warmer of claim 3, wherein a second end of the first telescopic part is provided with a baffle, the baffle is slidably connected to the side wall of the second telescopic part, and the baffle is configured to prevent the limit part from detaching from the inner wall of the first telescopic part.

5. The bottle warmer of claim 1, wherein a second end of the second telescopic part is provided with a temperature detection device, and the temperature detection device is electrically connected to the control panel.

6. The bottle warmer of claim 1, wherein the second side of the cover is provided with a sterilizing device, and the sterilizing device is electrically connected to the control panel.

7. The bottle warmer of claim 1, wherein the second side of the cover is provided with a circular protrusion, and a connection of the first telescopic part with the cover is provided within the circular protrusion.

8. The bottle warmer of claim 7, wherein the circular protrusion is provided in plurality, and a plurality of circular protrusions are provided concentrically around a center point of the second side of the cover; and for any adjacent two circular protrusions among a plurality of circular protrusions, one of the adjacent two circular protrusions close to a center point of the second side of the cover is smaller than the other of the adjacent two circular protrusions away from the center point in diameter.

9. The bottle warmer of claim 1, wherein the cover is provided with a display device, and the display device is electrically connected to the control panel.

10. The bottle warmer of claim 1, wherein the bottle warmer also comprises an accommodating box detachably connected to the cover, and the first telescopic part and the second telescopic part are configured to extend into the accommodating box.
